(19) United States
(12) Patent Application Publication
(10) Pub. No.: US 2023/0278744 A1
(43) Pub. Date: Sep. 7, 2023

(54) PAD SUPPORT FOR LABEL HOLDER

(71) Applicant: AMTIG ENGINEERING SOLUTIONS, LLC, Quincy, MI (US)

(72) Inventor: Steven GROHOLSKI, Quincy, MI (US)

(21) Appl. No.: 17/688,355

(22) Filed: Mar. 7, 2022

(51) Int. Cl. B65C 9/18

(52) U.S. Cl. CPC B65C 9/1884

(57) ABSTRACT

A suction strip for a label vacuum-grip cylinder. The suction strip comprising a slide plate and a pad at least partially received within the slide plate. When the at least one suction strip is inserted into the slot of the label vacuum-grip cylinder, the slot compresses the pad into a depression in the slide plate. The slide plate comprises a panel, a rearwardly extending wall extending rearwardly from the panel and a rear peripheral rim extending rearwardly from the rearwardly extending wall. The panel and the rearwardly extending wall define a suction area within the rearwardly extending wall. The depression is on a step defined by a surface of the rearwardly extending wall and within the rear peripheral rim. The slide plate including at least one retaining element for retaining the pad within the depression. Each of the slide plates can have a different character formed in the face thereof.

### FIELD OF THE INVENTION

The present invention relates to bottling, and in particular to an improved label holder.

### BACKGROUND OF THE INVENTION

Conveyor systems have been developed for quickly filling and capping a multitude of containers (e.g., bottles) in a very short period of time. The conveyor systems move empty containers (and uncapped if bottles) along a line and/or along a periphery of a wheel and fill the containers (with, for example, water, soda or any other liquid), close or cap the containers while the containers continuously move, and apply labels to the containers.

FIG. 1 illustrates a schematic portion of a container filling and labeling system 10 showing a schematic portion of a container labeling area 12. In the container labeling area 12, individual labels 14 from a single sheet of multiple labels 16 are applied to individual containers 18 (bottles as shown). As shown in FIG. 1, the single sheet of multiple labels 16 enters the illustrated container labeling area 12 for applying the labels 14 to the containers 18. The single sheet of multiple labels 16 can come from a label reel (not shown). As the single sheet of multiple labels 16 passes through the container labeling area 12, the single sheet of multiple labels 16 passes around a guide roller 20, through a pair of feed rollers 22, and onto a cutting unit 24. The cutting unit 24 cuts the single sheet of multiple labels 16 into the individual labels 14 while positioning the individual labels 14 onto a vacuum-grip cylinder 26. The vacuum-grip cylinder 26 passes the individual labels 14 over a hotmelt gluing unit 28 that applies hotmelt glue to a rear side of the individual labels 14 suctioned to the vacuum-grip cylinder 26. The containers 18 are positioned adjacent an outside of a container table 30. As shown in FIG. 1, the containers 18 are spun such that the rear side of the individual labels 14 that are brushed against the exterior of the containers 18 are adhered to the exterior of the containers 18.

In the prior art, the vacuum-grip cylinder 26 included various cylinders that were capable of holding the individual labels 14 via vacuum, allowing the glue to be applied to the rear side of the individual labels 14 suctioned to the vacuum-grip cylinder 26, and allowing the individual labels 14 to be applied to a cylindrical surface of the containers 18. An example of such a vacuum-grip cylinder 26 is disclosed in U.S. Pat. No. 8,408,267 entitled VACUUM CYLINDER FOR A LABELING APPARATUS, the entire contents of which are hereby incorporated herein by reference. The vacuum-grip cylinder 26 of U.S. Pat. No. 8,408,267 is illustrated in FIGS. 2-5.

FIG. 2 shows a perspective oblique view of vacuum-grip cylinder 26 of U.S. Pat. No. 8,408,267. The vacuum-grip cylinder 26 comprises a bottom support 32, although this is largely hidden in FIG. 2. The bottom support 32 is of rotationally symmetrical design and has a plurality of webs 34 extending in the radial direction. Cutouts 36 are provided between the individual webs 34. Supporting elements 38 connect the bottom support 32 to an upper support 40. The longitudinal direction L of the supporting elements 38 is perpendicular to the plane of the bottom support 32.

In FIG. 3, the plane of the bottom support 32 runs in the plane of the figure, and the longitudinal direction L of the supporting elements 38 is perpendicular thereto. The supporting elements 38 or the first end sections 38a thereof are releasably connected to the bottom support 32 via screw connections. Due to this releasability, a replacement of the individual supporting elements 38 and also a displacement of the supporting elements 38 in the circumferential direction of the vacuum-grip cylinder 26 is possible in a relatively simple manner. A hub 42 of the vacuum-grip cylinder 26 receives a rotating shaft (not shown) for rotating the vacuum-grip cylinder 26. A lower portion of the hub 42 is screwed to the bottom support 32 by a plurality of screw connections 44. The bottom support 32 has a ring 46 running in the circumferential direction and the individual supporting elements 38 are fixed thereto. The upper support 40 is designed in essentially the same way as the bottom support 32. Therefore, the upper support 40 also has a plurality of webs 48, between which respective cutouts 50 are arranged.

The individual supporting elements 38 or the upper end sections 38b thereof are connected to one another by a fixing ring 52. The upper support 40 likewise has a receiving opening 54 for receiving the shaft. A hub 56 of the upper support 40 is fixed to a fixing ring 58 by a plurality of screws 60.

The fixing of the supporting elements 38 to the bottom support 32 and the upper support 40 takes place via a plurality of screw connections 62. Suction strips 64a, 64b hold the start of an individual label 14 and the end of the individual label 14 to the vacuum-grip cylinder 26 by suction. In the embodiment shown in FIGS. 2-5, a total of twelve such suction strips 64a, 64b are provided. During operation, the start of an individual label 14 suctioned to the vacuum-grip cylinder 26 is arranged at the suction strips 64a and the end of the individual label 14 is arranged at the suction strips 64b. Segments 66 are provided in the circumferential direction between the suction strips 64a, 64b. The segments 66 are connected both to the bottom support 32 and also to the upper support 40 via a plurality of screw connections 68. The segments 66 have a plurality of suction openings 70 for air, which are arranged in suction rows. An opening 72 elongated in the circumferential direction of the segment 66 serves for optical monitoring of the presence of the individual labels 14 during operation. Located radially behind the suction openings 70 are vacuum chambers 74, which are connected to central suction points 76 (also shown in FIG. 3) via first vacuum lines 78. Openings 80 for sucking air are also provided in the suction strips 64a, 64b.

FIG. 3 shows a plan view of the vacuum-grip cylinder 26 from FIG. 2. Both the bottom support 32 and the upper support 40 have recesses 82a, 82b, in which the individual suction strips 64a, 64b are arranged. The respective second recesses 82b in the circumferential direction are wider than the width of the suction strips 64a, 64b in the circumferential direction. In this way, the suction strips 64a, 64b can be moved in the circumferential direction. A certain degree of adaptation to different labels and machine types can thus take place.

A quick-clamping ring 84 has a protrusion 86, through the displacement of which allows for release of the individual suction strips 64a, 64b for movement thereof. More specifically, once the quick-clamping ring 84 has been opened, the individual suction strips 64a, 64b can be removed from the vacuum-grip cylinder 26 in a direction perpendicular to the plane of the figure. The suction strips 64a, 64b in each case have an angled surface 88 which points in the direction of the segments 66. The individual angled surfaces 88 also protrude slightly beyond the circumference of the vacuum-grip cylinder 26 or the two supports 32 and 40 and also the segments 66, which allows for sucking up the individual labels 14 and prevents corrugations of the individual labels 14. The supporting elements 38 in each case have receiving grooves 90 for receiving the suction strips 64a, 64b.

FIG. 4 shows the vacuum-grip cylinder 26 wherein the individual suction strips 64a, 64b are not yet pushed fully into the vacuum-grip cylinder 26 in the longitudinal direction L. In an inner side of the suction strips 64a, 64b (i.e., the side pointing radially inwards), the suction strips 64a, 64b have a depression 92, in which a flexible material 94 or pad (FIG. 4) can be inserted, such as for example a piece of foam. In this way, the suction strips 64a, 64b can be moved slightly relative to the bottom support 32 and also the upper support 40 in the direction R and in the direction opposite thereto.

The quick-clamping ring 84 allows for the lock between the suction strips 64a, 64b and the supporting element 38 to be opened and in this way the suction strips 64a, 64b can easily be removed. The supporting element 38 has a rear wall 96, in which two openings are provided for the insertion of the first vacuum lines 78. The first vacuum lines 78 are connected to the rear wall 96 via the connecting pieces 98. In the embodiment shown here, the suction strips 64a, 64b are supplied by two first vacuum lines 78, while the vacuum chambers 74 behind the segments 66 are supplied by a second vacuum line 99. However, the number of these first vacuum lines 78 and second vacuum lines 99 can also be varied.

FIG. 5 shows a detail view of the diagram from FIG. 4. The flexible material 94 allows a movement of the suction strips 64a, 64b relative to the supporting elements 38 and thus relative to the bottom support 32 and also the upper support 40. Both the suction strips 64a, 64b and also the segments 66 are provided with an anti-adhesion coating or traction coating.

When using the container filling and labeling system 10 of the prior art having the container labeling area 12, the positioning of the suction strips 64a, 64b relative to the rest of the vacuum-grip cylinder 26 is very important. As outlined above, the suction strips 64a, 64b can be moved slightly relative to the bottom support 32 and also the upper support 40 in the direction R and in the direction opposite thereto. The suction strips 64a, 64b need to be positioned close enough to the hotmelt gluing unit 28 as the suction strips 64a, 64b are rotated past the hotmelt gluing unit 28 to be able to apply a sufficient amount of hotmelt glue to the rear side of the individual labels 14 suctioned to the vacuum-grip cylinder 26 without abutting the hotmelt gluing unit 28 as the suction strips 64a, 64b pass by the hotmelt gluing unit 28. As the size and location of the hotmelt gluing unit 28 and the containers 18 can vary, a system for properly positioning the suction strips 64a, 64b before use of the container filling and labeling system 10 is needed.

FIGS. 6-8 illustrate an example of the prior art suction strip 64 comprising a slide plate 100 and the pad 94 of flexible material inserted therein. The slide plate 100 (FIGS. 9-13) includes a panel 102, a rectangular rearwardly extending wall 104 and a rear peripheral rim 106. The panel 102 of the slide plate 100 of the suction strip 64 includes an outwardly positioned face 113 when the suction strip 64 is on the vacuum-grip cylinder 26. The outwardly positioned face 113 of the panel 102 includes a flat area 112 and a raised suction angled surface 88 extending outwardly from the flat area 112. The panel 102 and the raised suction angled surface 88 have suction channels 110 therethrough that provide suction for sucking the labels 14 against the suction strip 64. The rectangular rearwardly extending wall 104 extends rearwardly from the panel 102.

As illustrated in FIGS. 6, 9, 11 and 13, the illustrated rectangular rearwardly extending wall 104 includes three wall sections 114 coinciding with a periphery of the panel 102 and a fourth side wall section 116 located inwardly from a periphery of the panel 102 such that a cantilevered portion 118 of the panel 102 is formed. The panel 102 and the rectangular rearwardly extending wall 104 define a suction area 120 therein. The suction channels 110 open into the suction area 120.

The illustrated rear peripheral rim 106 extends rearwardly from the rectangular rearwardly extending wall 104 and forms a pad support step 122 on a rearward surface of the rectangular rearwardly extending wall 104 and inward of the rear peripheral rim 106. The rear peripheral rim 106 includes a top rim section 115 and a bottom rim section 117 as viewed from a position when the suction strip 64 is positioned within the vacuum-grip cylinder 26. The top rim section 115 and the bottom rim section 117 have an outer periphery coplanar with the periphery of the rectangular rearwardly extending wall 104. Side rim sections 119 of the rear peripheral rim 106 extend between the top rim section 115 and the bottom rim section 117. The side rim sections 119 have an inner surface coplanar with an inner periphery of the rectangular rearwardly extending wall 104. The side rim sections 119 extend outboard of the rectangular rearwardly extending wall 104 to form a pair of opposite and parallel slide ledges 130. The pair of opposite and parallel slide ledges 130 are for sliding within corresponding slots in the vacuum-grip cylinder 26 to connect the suction strip 64 to the vacuum-grip cylinder 26.

In the illustrated example, the pad 94 (FIGS. 14 and 15) is positioned in the depression 92 on the pad support step 122 within the rear peripheral rim 106. The suction area 120 is defined between the panel 102, the pad 94 and the rectangular rearwardly extending wall 104. The pad 94 has a substantially rectangular profile and has a peripheral edge 124 conforming to the shape of the interior periphery of the rear peripheral rim 106. The pad 94 includes a pair of centrally located openings 126 to allow a suction force to be supplied to the suction area 120.

When the suction strip 64 is slid into the vacuum-grip cylinder 26, the pad 94 is compressed and maintains the suction strip 64 within the vacuum-grip cylinder 26. Such compression helps to seal the suction area 120. During use of the prior art suction strips 64, the pads 94 can sometimes lose their structural integrity and be suctioned into the suction area 120, thereby substantially reducing the amount of suction force within the suction area 120. The reduction of the amount of suction force within the suction area 120 can cause the labels 14 to not be properly suctioned to the vacuum-grip cylinder 26, causing misplacement of the labels 14 on the containers 18. In this situation, the container filling and labeling system 10 needs to be shut down until a new pad 94 and/or entire suction strip 64 can be replaced. Since the container filling and labeling system 10 works continuously, any shutdown of the container filling and labeling system 10 can prevent thousands of containers from being ready for shipping, costing the factories large amounts of money. Therefore, there is a desire to prevent and/or lessen the shutdown time of the container filling and labeling system 10.

### SUMMARY OF THE INVENTION

The present invention, according to one aspect, is directed to a labeling apparatus comprising a label vacuum-grip cylinder having a plurality of slots, with the label vacuum-grip cylinder being configured to supply a vacuum force to the slots, and at least one suction strip configured to be inserted into one of the slots of the label vacuum-grip cylinder for suctioning a label against a face of the at least one suction strip. The at least one suction strip comprises a slide plate and a pad at least partially received within the slide plate. When the at least one suction strip is inserted into the one of the slots of the label vacuum-grip cylinder, the one of the slots compresses the pad into a depression in the slide plate. The slide plate comprises a panel, a rearwardly extending wall extending rearwardly from the panel and a rear peripheral rim extending rearwardly from the rearwardly extending wall. The panel and the rearwardly extending wall define a suction area within the rearwardly extending wall. The depression is on a step defined by a surface of the rearwardly extending wall and within the rear peripheral rim. The suction strip includes at least one means for retaining the pad within the depression.

Another aspect of the present invention is to provide a labeling apparatus comprising a label vacuum-grip cylinder having a plurality of slots, with the label vacuum-grip cylinder being configured to supply a vacuum force to the slots, and at least one suction strip configured to be inserted into one of the slots of the label vacuum-grip cylinder for suctioning a label against a face of the at least one suction strip. The at least one suction strip comprises a slide plate and a pad at least partially received within the slide plate. When the at least one suction strip is inserted into the one of the slots of the label vacuum-grip cylinder, the one of the slots compresses the pad into a depression in the slide plate. The slide plate comprises a panel, a rearwardly extending wall extending rearwardly from the panel and a rear peripheral rim extending rearwardly from the rearwardly extending wall. The panel and the rearwardly extending wall define a suction area within the rearwardly extending wall. The depression is on a step defined by a surface of the rearwardly extending wall and within the rear peripheral rim. The slide plate includes at least one pin extending from the step for retaining the pad within the depression.

Yet another aspect of the present invention is to provide a labeling part comprising a suction strip configured to be inserted into a slot of a label vacuum-grip cylinder to have a vacuum force supplied to the suction strip for suctioning a label against a face of the suction strip. The suction strip comprises a slide plate and a pad at least partially received within the slide plate, wherein when the suction strip is configured to be inserted into the slot of the label vacuum-grip cylinder such that the slot compresses the pad into a depression in the slide plate. The slide plate comprises a panel, a rearwardly extending wall extending rearwardly from the panel and a rear peripheral rim extending rearwardly from the rearwardly extending wall. The panel and the rearwardly extending wall define a suction area within the rearwardly extending wall. The depression is on a step defined by a surface of the rearwardly extending wall and within the rear peripheral rim. The slide plate including at least one pin extending from the step for retaining the pad within the depression.

Another aspect of the present invention is to provide a labeling apparatus comprising a label vacuum-grip cylinder having a plurality of slots, with the label vacuum-grip cylinder being configured to supply a vacuum force to the slots. The labeling apparatus further comprises a plurality of suction strips. Each of the suction strips has a face. Each of the suction strips is configured to be inserted into one of the slots of the label vacuum-grip cylinder for suctioning a label against each face of each of the suction strips. Each of the suction strips comprises a slide plate and a pad at least partially received within the slide plate. When the suction strips are inserted into the one of the slots of the label vacuum-grip cylinder, the one of the slots compresses the pad into a depression in the slide plate. Each of the slide plates comprises a panel, a rearwardly extending wall extending rearwardly from the panel and a rear peripheral rim extending rearwardly from the rearwardly extending wall. The panel and the rearwardly extending wall define a suction area within the rearwardly extending wall. The depression is on a step defined by a surface of the rearwardly extending wall and within the rear peripheral rim. Each of the slide plates has a different character formed in the face of each of the suction strips.

### BRIEF DESCRIPTION OF THE DRAWINGS

One or more embodiments of the present invention are illustrated by way of example and should not be construed as being limited to the specific embodiments depicted in the accompanying drawings, in which like reference numerals indicate similar elements.

FIG. 1 is a schematic view of a prior art container filling and labeling system.

FIG. 2 is a perspective view of a prior art vacuum-grip cylinder.

FIG. 3 is a top view of the prior art vacuum-grip cylinder.

FIG. 4 is a detail view of the prior art vacuum-grip cylinder with suction strips partially pushed out.

FIG. 5 is a partial plan view of the prior art view from FIG. 4.

FIG. 6 is a perspective view of the prior art suction strip.

FIG. 7 is a side view of the prior art suction strip.

FIG. 8 is an exploded side view of the prior art suction strip.

FIG. 9 is a perspective view of a slide plate of the prior art suction strip.

FIG. 10 is a front view of the slide plate of the prior art suction strip.

FIG. 11 is a rear view of the slide plate of the prior art suction strip.

FIG. 12 is a cross-sectional view of the slide plate of the prior art suction strip.

FIG. 13 is an end view of the slide plate of the prior art suction strip.

FIG. 14 is a perspective view of a pad of the prior art suction strip.

FIG. 15 is a rear view of the pad of the prior art suction strip.

FIG. 16 is a perspective view of a suction strip according to an embodiment of the present invention.

FIG. 17 is a side view of the suction strip according to an embodiment of the present invention.

FIG. 18 is an exploded side view of the suction strip according to an embodiment of the present invention.

FIG. 19 is a perspective view of a slide plate of the suction strip according to an embodiment of the present invention.

FIG. 20 is a rear view of the slide plate of the suction strip according to an embodiment of the present invention.

FIG. 21 is a front view of the slide plate of the prior art suction strip.

FIG. 22 is a cross-sectional view of the slide plate of the suction strip according to an embodiment of the present invention taken along line XXII-XXII of FIG. 21.

FIG. 23 is a cross-sectional view of the slide plate of the suction strip according to an embodiment of the present invention taken along line XXIII-XXIII of FIG. 21.

FIG. 24 is an end view of the slide plate of the suction strip according to an embodiment of the present invention.

FIG. 25 is a perspective view of a pad of the suction strip according to an embodiment of the present invention.

FIG. 26 is a rear view of the pad of the suction strip according to an embodiment of the present invention.

FIG. 27 is a front view of a suction strip according to an embodiment of the present invention with a character in a front face thereof.

FIG. 28 is a rear view of a label illustrating a character void on a rear face thereof.

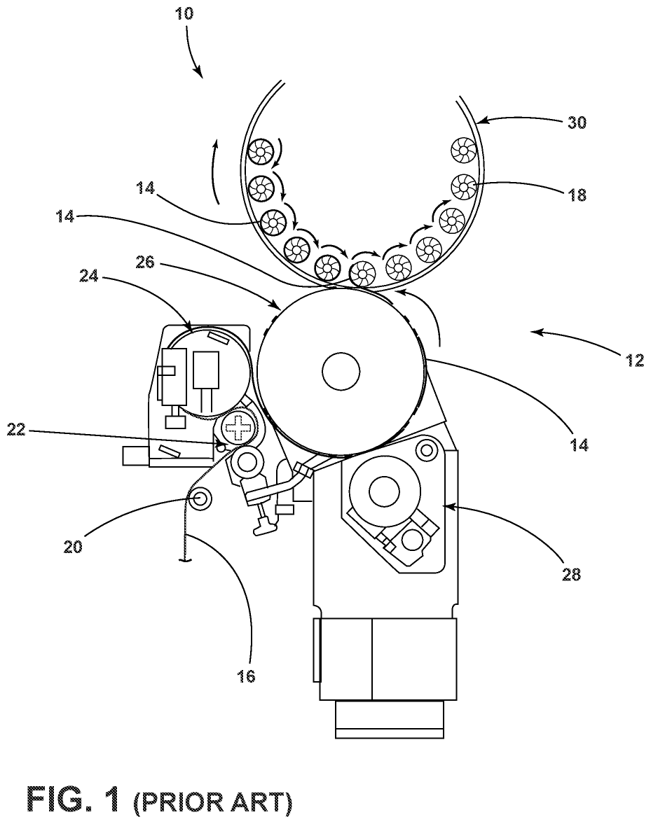

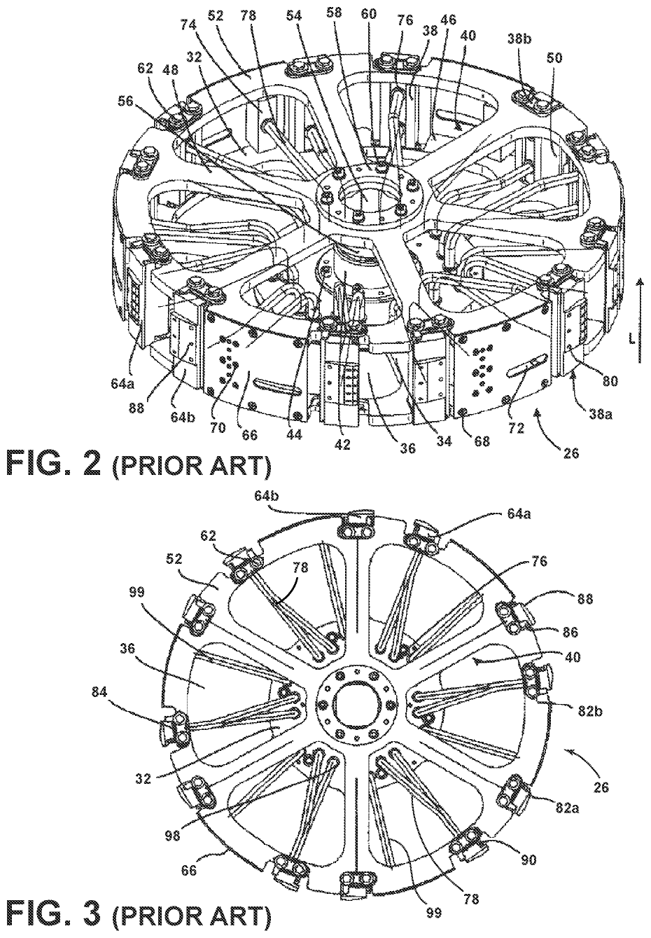

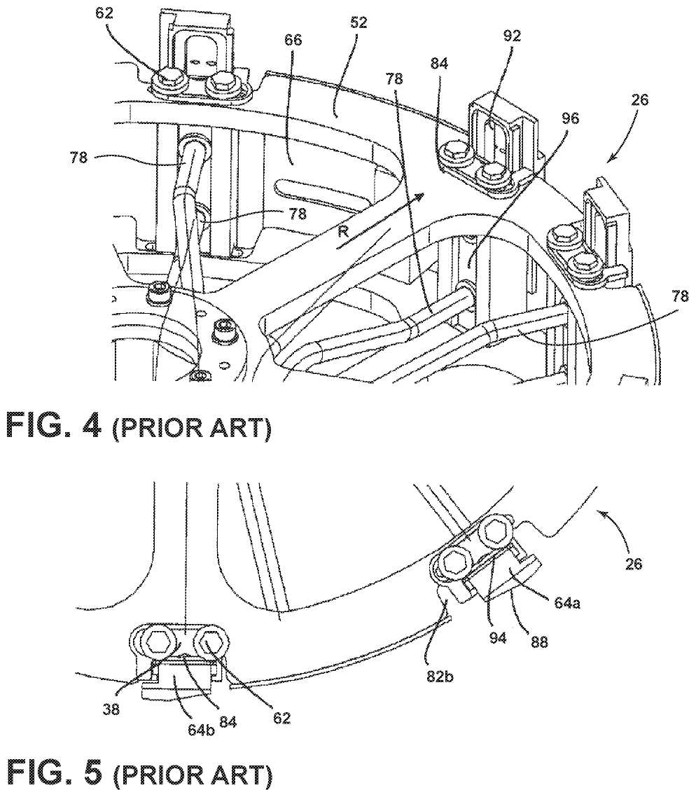

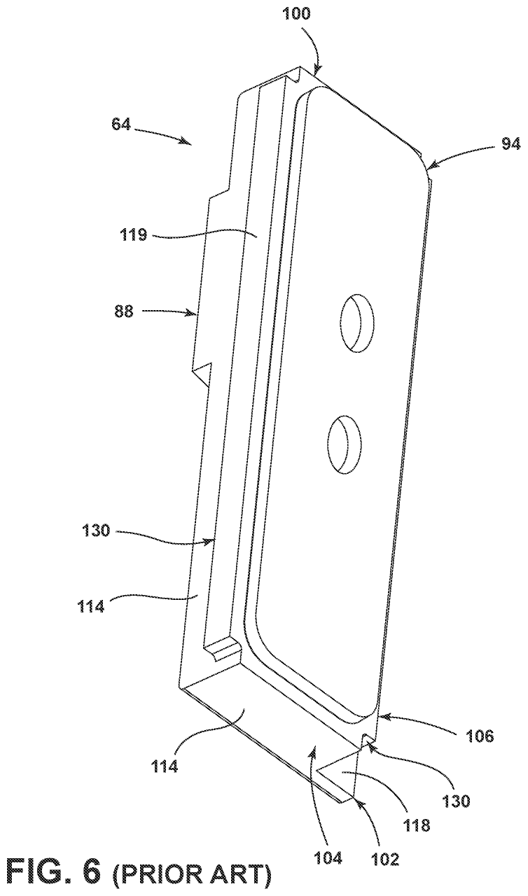

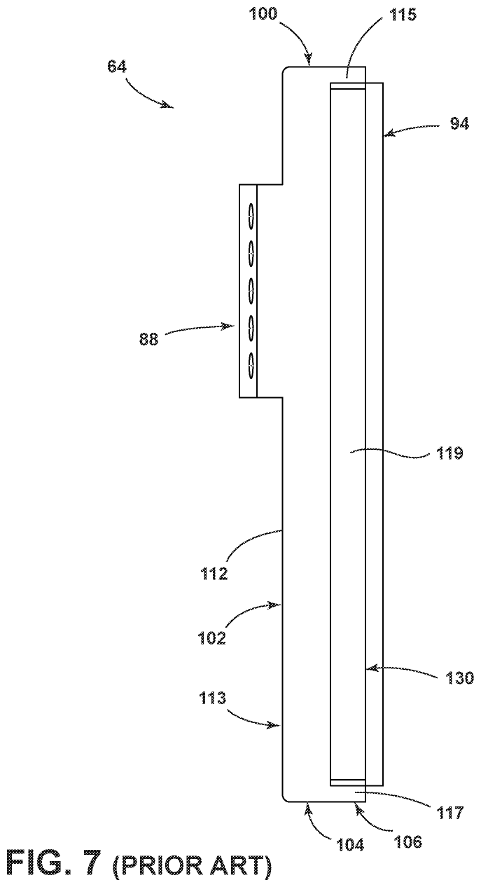

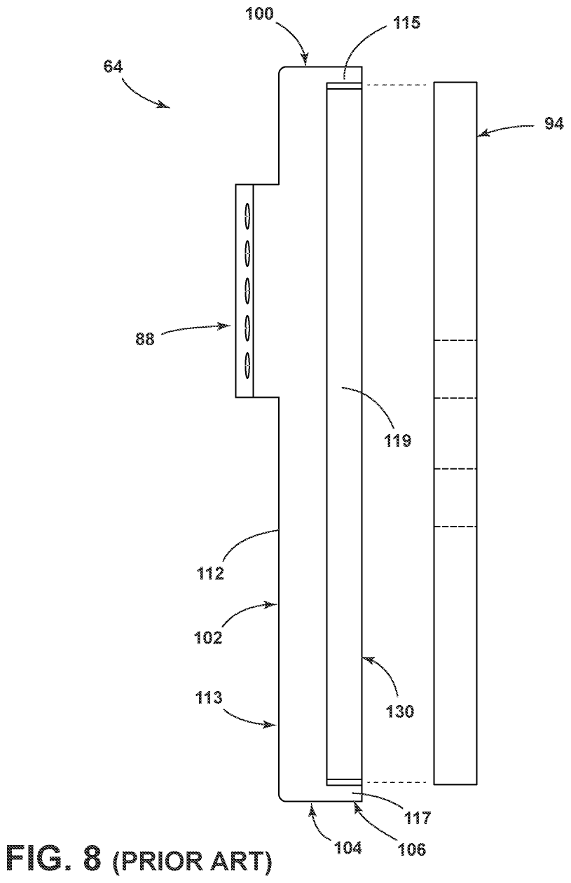

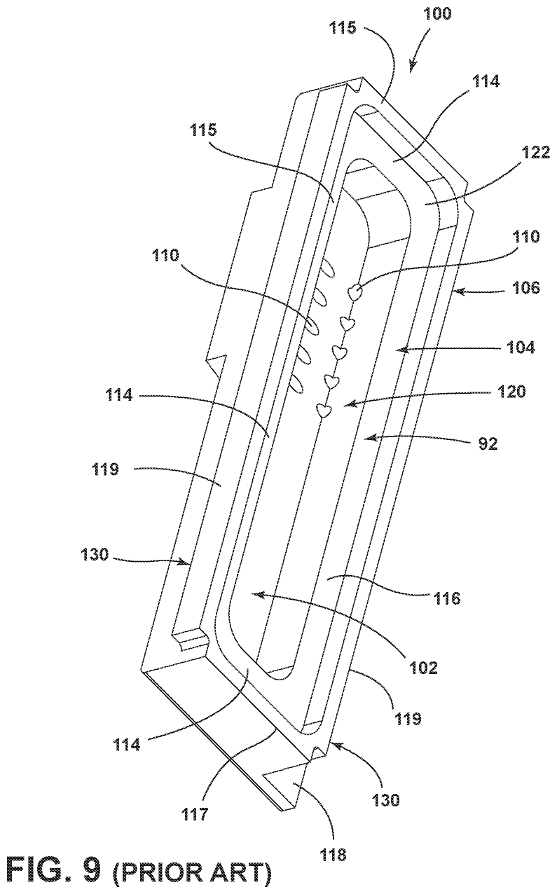

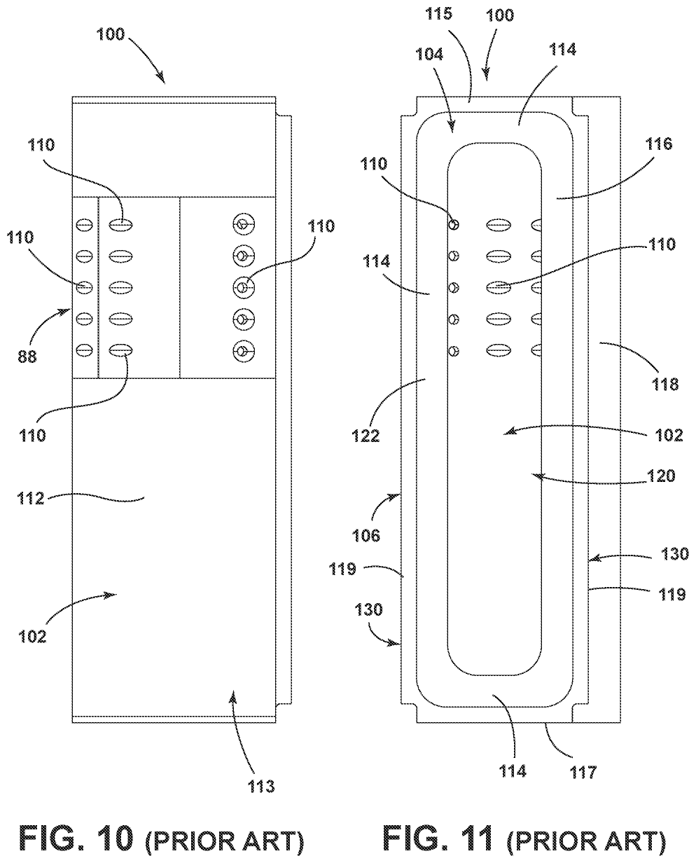

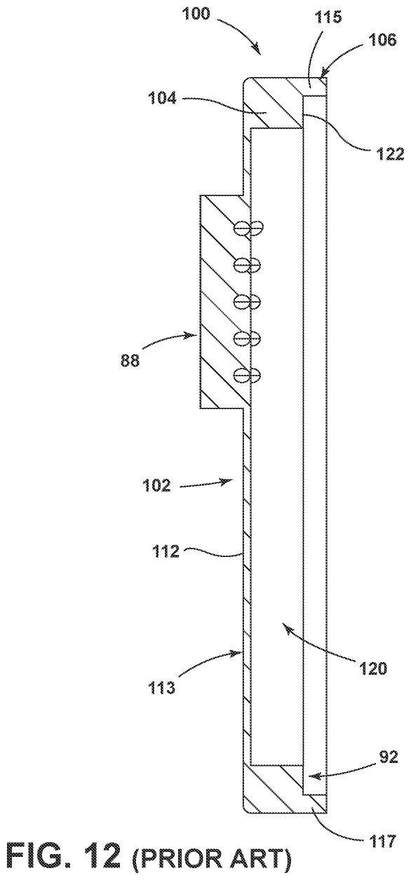

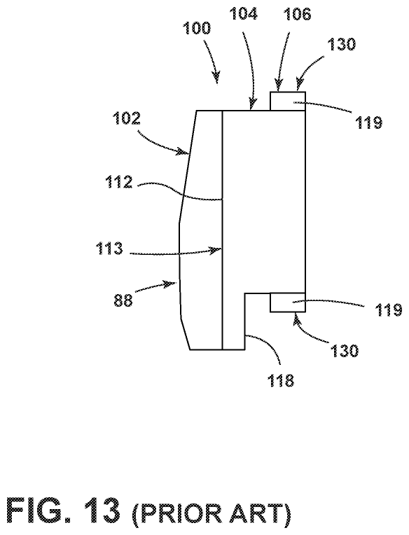

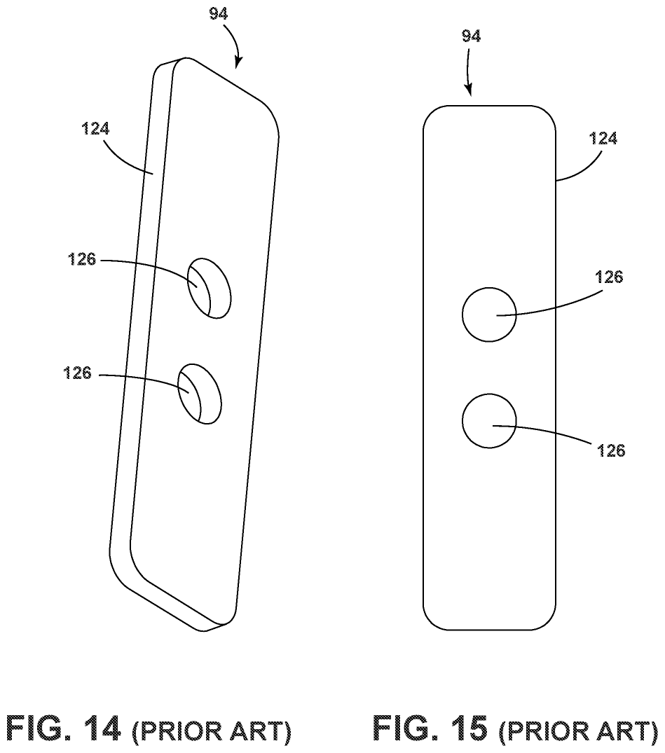

The specific devices and processes illustrated in the attached drawings and described in the following specification are simply exemplary embodiments of the inventive concepts. Hence, specific dimensions and other physical characteristics relating to the embodiments disclosed herein are not to be considered as limiting.

### DETAILED DESCRIPTION

For purposes of description herein, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

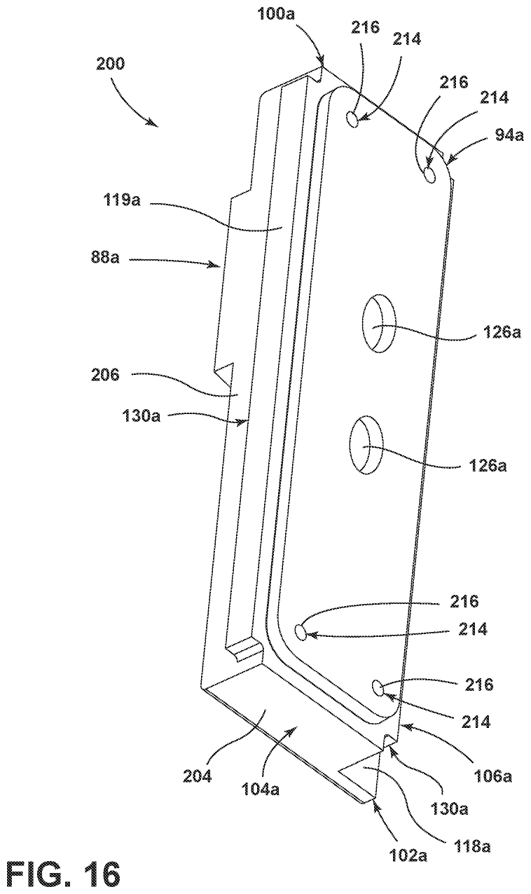

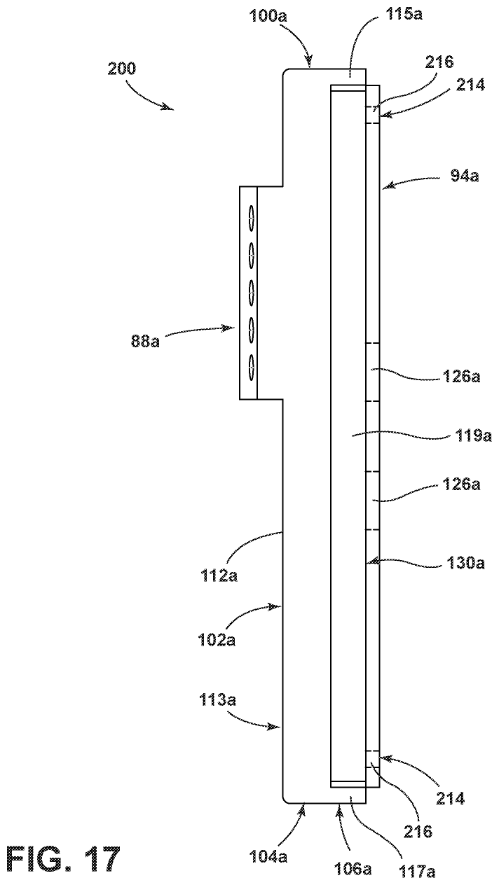

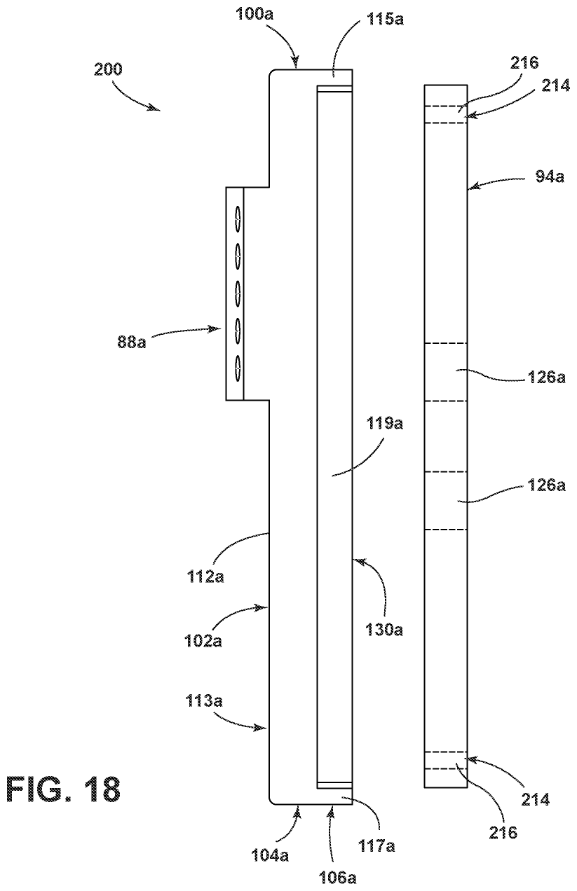

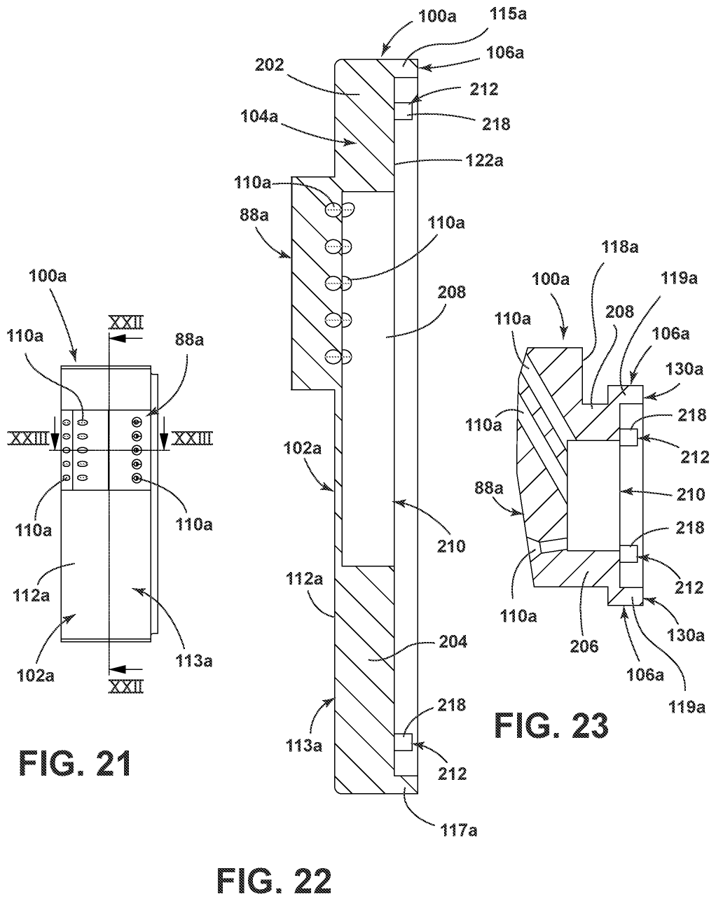

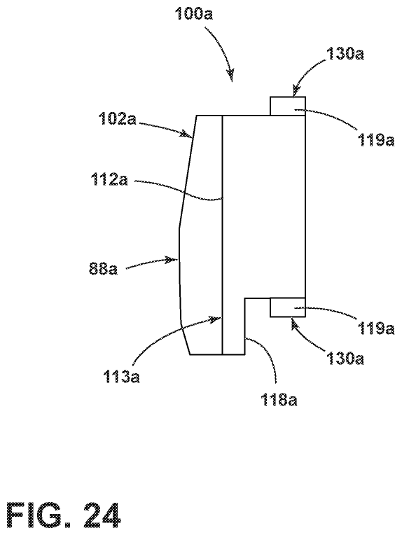

The reference number 200 (FIGS. 16-26) generally designates a suction strip of the present invention. The suction strip 200 of the present invention is a significant improvement over the prior art suction strip 64 in preventing failure of the pad 94 of the prior art as discussed above. The suction strip 200 of the present invention includes one or more of the following three improvements over the prior art suction strip 64: a smaller suction area 210, pad retaining features 212 on a slide plate 100a and retention features 214 on a pad 94a of flexible material configured to engage with the pad retaining features 212 on the slide plate 100a. The suction strip 200 of the present invention is configured to be slid into the vacuum-grip cylinder 26 of the prior art in the same manner of the suction strip 64 of the prior art. However, the suction strip 200 of the present invention has superior failure prevention characteristics.

In the illustrated example, the suction strip 200 of the present invention comprises the slide plate 100a of the present invention and the pad 94a of the present invention inserted therein. The slide plate 100a (FIGS. 16-24) includes a panel 102a, a rectangular rearwardly extending wall 104a and a rear peripheral rim 106a. The panel 102a of the slide plate 100a of the suction strip 200 includes an outwardly positioned face 113a when the suction strip 200 is on the vacuum-grip cylinder 26. The outwardly positioned face 113a of the panel 102a includes a flat area 112a and a raised suction angled surface 88a extending outwardly from the flat area 112a. The panel 102a and the raised suction angled surface 88a have suction channels 110a therethrough that provide suction for sucking the labels 14 against the suction strip 200. The rectangular rearwardly extending wall 104a extends rearwardly from the panel 102a.

As illustrated in FIGS. 16, 19 and 20, the illustrated rectangular rearwardly extending wall 104a includes a top wall section 202, a bottom wall section 204, a first side wall section 206 and a second side wall section 208 as viewed from a position when the suction strip 200 is positioned within the vacuum-grip cylinder 26. The top wall section 202, the bottom wall section 204, the first side wall section 206 coincide with a periphery of the panel 102a. The second side wall section 208 is located inwardly from a periphery of the panel 102a such that a cantilevered portion 118a of the panel 102a is formed.

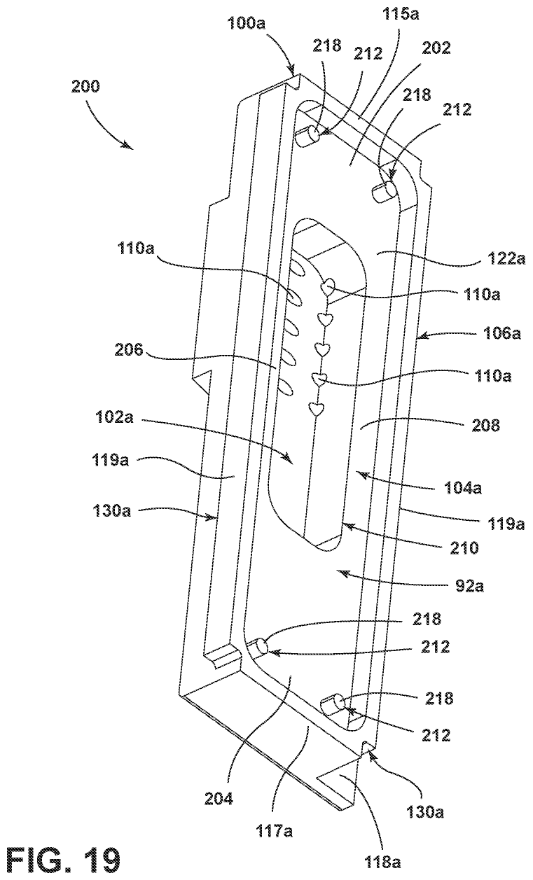

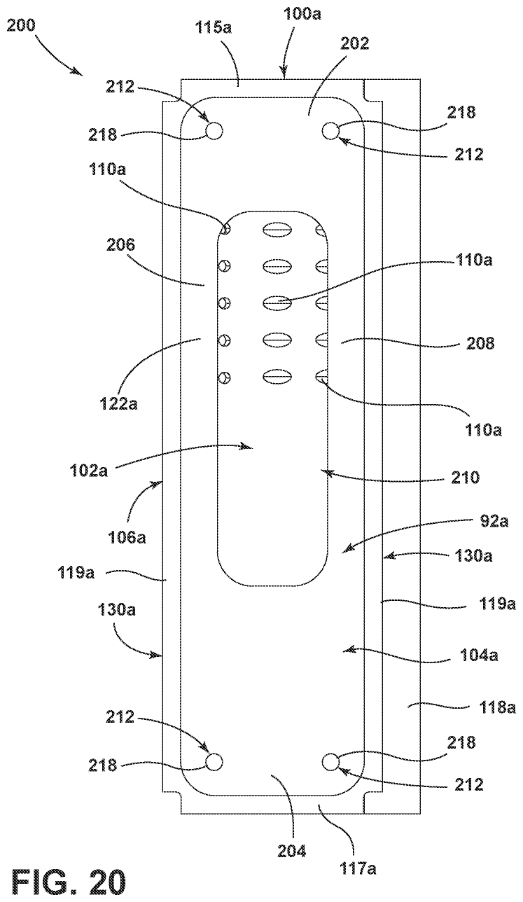

The illustrated panel 102a and the rectangular rearwardly extending wall 104a of the slide plate 100a define the smaller suction area 210. The suction channels 110a open into the smaller suction area 210. The rear peripheral rim 106a extends rearwardly from the rectangular rearwardly extending wall 104a and forms a pad support step 122a on a rearward surface of the rectangular rearwardly extending wall 104a and inward of the rear peripheral rim 106a. As illustrated in FIGS. 19 and 20, the rectangular rearwardly extending wall 104a of the suction strip 200 of the present invention is substantially thicker than the rectangular rearwardly extending wall 104 of the prior art suction strip 64, such that the smaller suction area 210 of the suction strip 200 of the present invention is substantially smaller than the suction area 120 of the prior art suction strip 64. It is contemplated that the area defined by the pad support step 122a can be larger than the area defined by the opening to the smaller suction area 210 to better support the pad 94a on the pad support step 122a and to prevent the pad 94a from being suctioned into the smaller suction area 210.

The rear peripheral rim 106a includes a top rim section 115a and a bottom rim section 117a as viewed from a position when the suction strip 200 is positioned within the vacuum-grip cylinder 26. The top rim section 115a and the bottom rim section 117a have an outer periphery coplanar with the periphery of the rectangular rearwardly extending wall 104a. Side rim sections 119a of the rear peripheral rim 106a extend between the top rim section 115a and the bottom rim section 117a. The side rim sections 119a have an inner surface coplanar with an inner periphery of the rectangular rearwardly extending wall 104a. The side rim sections 119a extend outboard of the rectangular rearwardly extending wall 104a to form a pair of opposite and parallel slide ledges 130a. The pair of opposite and parallel slide ledges 130a are for sliding within corresponding slots in the vacuum-grip cylinder 26 to connect the suction strip 200 to the vacuum-grip cylinder 26.

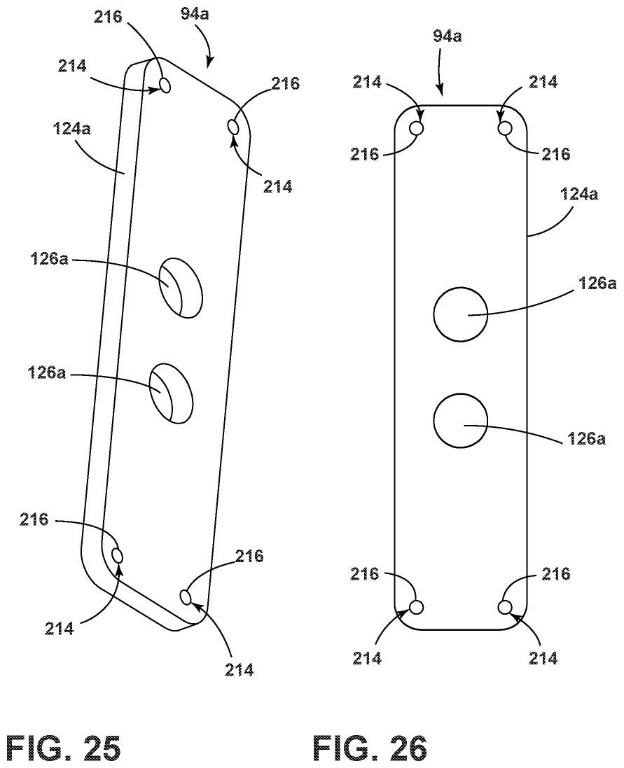

In the illustrated example, the pad 94a (FIGS. 25 and 26) is positioned in a depression 92a on the pad support step 122a within the rear peripheral rim 106a. The smaller suction area 210 is defined between the panel 102a, the pad 94a and the rectangular rearwardly extending wall 104a. The pad 94a has a substantially rectangular profile and has a peripheral edge 124a conforming to the shape of the interior periphery of the rear peripheral rim 106a. The pad 94a includes a pair of centrally located openings 126a to allow a suction force to be supplied to the smaller suction area 120a.

The illustrated pad 94a and the slide plate 100a include features for maintaining the pad 94 in position in the depression 92a. As set forth above, the slide plate 100a includes pad retaining features 212. In the illustrated example, the pad retaining features 212 comprises pins 218 extending upwardly from the pad support step 122a at each corner thereof. It is contemplated that the slide plate 100a could include any number of pad retaining features 212 at any location thereon for maintaining the pad 94 in position in the depression 92a. For example, the slide plate 100a could include any number of pins 218 at any location on the pad support step 122a (e.g., only two pins 218 or more than four pins 218). The pad retaining features 212 could also include spikes or hooks to hold the pad in position in the depression 92a.

In the illustrated example, the pad 94 includes retention features 214 configured to interact with the pad retaining features 212 to further help in maintaining the pad 94 in position in the depression 92a. In the illustrated example, the retention features 214 comprises holes 216 extending through the pad 94a adjacent each corner thereof. The holes 216 are configured to receive the pins 218. It is contemplated that the pad 94a could include any number of retention features 214 at any location thereon for maintaining the pad 94a in position in the depression 92a. For example, the pad 94a could include any number of holes 216 at any location on the pad 94a (e.g., only two holes 216 or more than four holes 216). It is contemplated that the pad 94a includes the same number of holes 216 as the number of pins 218 and in corresponding locations.

When the suction strip 200 of the present invention is slid into the vacuum-grip cylinder 26, the pad 94a is compressed and maintains the suction strip 200 within the vacuum-grip cylinder 26. Such compression helps to seal the smaller suction area 210. In the illustrated example, any one of the smaller suction area 210 (and corresponding larger pad support step 122a), the pad retaining features 212 and/or the retention features 214 help to assist in maintaining the pad 94 in position in the depression 92a and preventing failure of the suction strips 200. However, a combination of all three of the smaller suction area 210, the pad retaining features 212 and the retention features 214 maximize the amount of assistance in maintaining the pad 94 in position in the depression 92a and preventing failure of the suction strips 200.

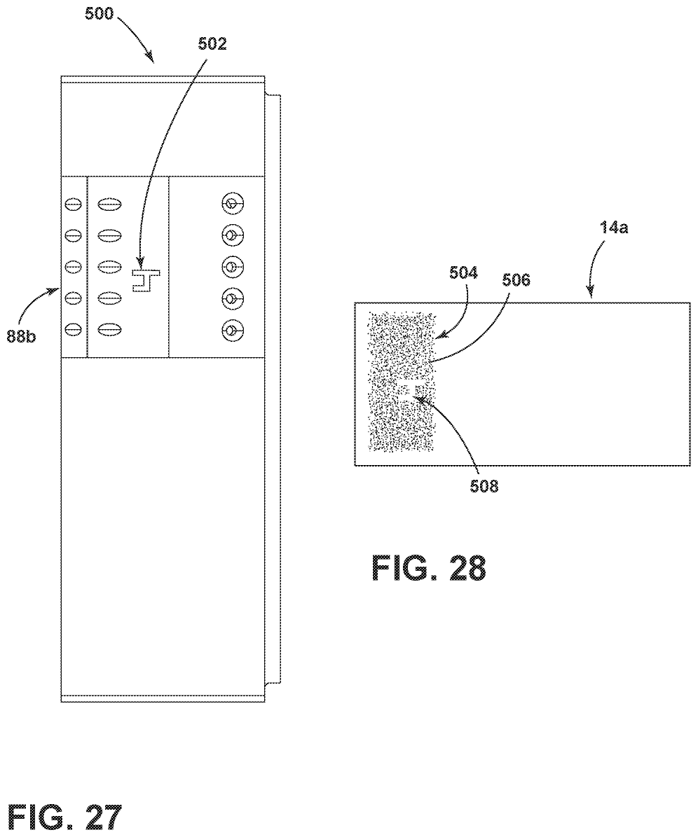

As outlined above, the vacuum-grip cylinder 26 includes a plurality of suctions strips 64, 200 thereon. When one of the suction strips 64, 200 fails, it can be difficult to determine which suction strip 64, 200 is failing. FIG. 27 illustrates a suction strip 500 for assisting in determining which suction strip 500 is failing. As shown in FIG. 27, the angled surfaces 88b of the suction strip 500 includes a character 502 formed therein. The character 502 can be any graphic symbol (e.g., number, letter, or symbol). However, each suction strip 500 of the vacuum-grip cylinder 26 has a different character 502. For example, the characters 502 on the suction strips 500 can each be numbered 1 through 8. It is contemplated that the character 502 could be added to either the prior art suction strip 64 or the suction strip 200 of the present invention.

FIG. 28 illustrates a rear side of an individual label 14a that has glue placed thereon by the suction strip 500 with the character 502 formed therein. As shown in FIG. 28, the individual label 14a includes a glue area 504 having glue 506 thereon. The glue area 504 has a mirror image character void area 508 therein with no glue 506 because the character 502 formed in the suction strip 500 prevented such mirror image character void area 508 from having glue 506 placed thereon. If the container manufacturer notices that a number of labels 14a are not properly adhering to containers 18 and that each of the labels 14a has the same mirror image character void area 508 thereon, the container manufacturer will be able to easily identify the particular suction strip 500 that is failing because the mirror image character void area 508 on the failing labels 14a will be the mirror image of the character 502 on the suction strip 500 that is failing. The container manufacturer will therefore know exactly which suction strip 500 to replace and/or fix without any further investigation. Therefore, the down time of the container filling and labeling system 10 in order to fix the vacuum-grip cylinder 26 will be minimized.

It is contemplated that the character 502 can be formed in the suction strip 500 in any manner. For example, the character 502 can be etched into the suction strip 500. In such an example, the slide plate 100, 100a is formed from 7075 aluminium alloy with a black hardcoat anodizing finish. High velocity oxygenated fuel is then employed to spray 420 stainless steel onto the angled surfaces 88b. A laser then etches the character 502 into the angled surfaces 88b.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. A labeling apparatus comprising:
a label vacuum-grip cylinder having a plurality of slots, the label vacuum-grip cylinder being configured to supply a vacuum force to the slots; and
at least one suction strip configured to be inserted into one of the slots of the label vacuum-grip cylinder for suctioning a label against a face of the at least one suction strip, the at least one suction strip comprising a slide plate and a pad at least partially received within the slide plate, wherein when the at least one suction strip is inserted into the one of the slots of the label vacuum-grip cylinder, the one of the slots compresses the pad into a depression in the slide plate;
the slide plate comprising a panel, a rearwardly extending wall extending rearwardly from the panel and a rear peripheral rim extending rearwardly from the rearwardly extending wall, the panel and the rearwardly extending wall defining a suction area within the rearwardly extending wall, the depression on a step defined by a surface of the rearwardly extending wall and within the rear peripheral rim; and
the suction strip including at least one means for retaining the pad within the depression.

2. The labeling apparatus of claim 1, wherein:
the at least one means for retaining the pad within the depression comprises at least one pin extending from the step.

3. The labeling apparatus of claim 2, wherein:
the pin is cylindrical.

4. The labeling apparatus of claim 2, wherein:
the at least one means for retaining the pad within the depression comprises at least one hole in the pad, the at least one hole receiving the at least one pin therein.

5. The labeling apparatus of claim 4, wherein:
the at least one pin comprises four pins; and
at least one hole comprises four holes, each hole being located at a corner of the pad.

6. The labeling apparatus of claim 1, wherein:
a first area defined by the entire surface of the step is larger than a second area defined by an opening into the suction area in a center portion of the step.

7. The labeling apparatus of claim 1, wherein:
the slide plate includes a character formed in the face of the suction strip.

8. A labeling apparatus comprising:
a label vacuum-grip cylinder having a plurality of slots, the label vacuum-grip cylinder being configured to supply a vacuum force to the slots; and
at least one suction strip configured to be inserted into one of the slots of the label vacuum-grip cylinder for suctioning a label against a face of the at least one suction strip, the at least one suction strip comprising a slide plate and a pad at least partially received within the slide plate, wherein when the at least one suction strip is inserted into the one of the slots of the label vacuum-grip cylinder, the one of the slots compresses the pad into a depression in the slide plate;
the slide plate comprising a panel, a rearwardly extending wall extending rearwardly from the panel and a rear peripheral rim extending rearwardly from the rearwardly extending wall, the panel and the rearwardly extending wall defining a suction area within the rearwardly extending wall, the depression on a step defined by a surface of the rearwardly extending wall and within the rear peripheral rim;
the slide plate including at least one pin extending from the step for retaining the pad within the depression.

9. The labeling apparatus of claim 8, wherein:
the pin is cylindrical.

10. The labeling apparatus of claim 8, further including:
at least one hole in the pad, the at least one hole receiving the at least one pin therein.

11. The labeling apparatus of claim 10, wherein:
the at least one pin comprises four pins; and
at least one hole comprises four holes, each hole being located at a corner of the pad.

12. The labeling apparatus of claim 8, wherein:
a first area defined by the entire surface of the step is larger than a second area defined by an opening into the suction area in a center portion of the step.

13. The labeling apparatus of claim 1, wherein:
the slide plate includes a character formed in the face of the suction strip.

14. A labeling part comprising:
a suction strip configured to be inserted into a slot of a label vacuum-grip cylinder to have a vacuum force supplied to the suction strip for suctioning a label against a face of the suction strip;
the suction strip comprising a slide plate and a pad at least partially received within the slide plate, wherein when the suction strip is configured to be inserted into the slot of the label vacuum-grip cylinder such that the slot compresses the pad into a depression in the slide plate;
the slide plate comprising a panel, a rearwardly extending wall extending rearwardly from the panel and a rear peripheral rim extending rearwardly from the rearwardly extending wall, the panel and the rearwardly extending wall defining a suction area within the rearwardly extending wall, the depression on a step defined by a surface of the rearwardly extending wall and within the rear peripheral rim; and
the slide plate including at least one pin extending from the step for retaining the pad within the depression.

15. The labeling part of claim 14, wherein:
the pin is cylindrical.

16. The labeling part of claim 14, wherein:
the pad comprises at least one hole, the at least one hole receiving the at least one pin therein.

17. The labeling part of claim 16, wherein:
the at least one pin comprises four pins; and
at least one hole comprises four holes, each hole being located at a corner of the pad.

18. The labeling part of claim 14, wherein:
a first area defined by the entire surface of the step is larger than a second area defined by an opening into the suction area in a center portion of the step.

19. The labeling part of claim 14, wherein:
the slide plate includes a character formed in the face of the suction strip.

20. A labeling apparatus comprising:
a label vacuum-grip cylinder having a plurality of slots, the label vacuum-grip cylinder being configured to supply a vacuum force to the slots; and
a plurality of suction strips, each of the suction strips having a face, each of the suction strips being configured to be inserted into one of the slots of the label vacuum-grip cylinder for suctioning a label against each face of each of the suction strips, each of the suction strips comprise a slide plate and a pad at least partially received within the slide plate, wherein when each of the suction strips are inserted into the one of the slots of the label vacuum-grip cylinder, the one of the slots compresses the pad into a depression in the slide plate;
the slide plate comprising a panel, a rearwardly extending wall extending rearwardly from the panel and a rear peripheral rim extending rearwardly from the rearwardly extending wall, the panel and the rearwardly extending wall defining a suction area within the rearwardly extending wall, the depression on a step defined by a surface of the rearwardly extending wall and within the rear peripheral rim;
each of the slide plates having a different character formed in the face of each of the suction strips.

21. The labeling apparatus of claim 20, wherein:
each of the slide plates has the different character etched into the face thereof.
